(19) United States
(12) Patent Application Publication
(10) Pub. No.: US 2005/0158539 A1
(43) Pub. Date: Jul. 21, 2005

(54) Pressure-sensitive adhesive tapes

(75) Inventors: Thomas S. Murphy, Boxford, MA (US); Stanley J. Piaseczynski, Epping, NH (US)

Correspondence Address: WILMER CUTLER PICKERING HALE AND DORR LLP, 60 STATE STREET, BOSTON, MA, 02109, US

(73) Assignee: Andover Coated Products, Inc., Salisbury, MA (US)

(21) Appl. No.: 10/603,224

(22) Filed: Jun. 25, 2003

(51) Int. Cl. B32B 27/12

(52) U.S. Cl. 428/343; 442/149; 428/304.4

(57) ABSTRACT

A vapor permeable article includes a porous backing substrate and an open fabric applied to one surface of the backing substrate. The open fabric has a greater porosity than that of the backing substrate. The open fabric is coated with an adhesive in such a manner that the open fabric remains porous and vapor permeable. The coated article can have a greater tensile strength in the cross direction than in the machine direction, and the adhesive can penetrate into at least a portion of a thickness of the porous backing.

### FIELD OF THE INVENTION

The present invention is directed to pressure-sensitive adhesive articles, and more particularly to water vapor permeable, pressure-sensitive adhesive articles. In particular, the invention relates to breathable, pressure-sensitive adhesive products that are readily and evenly tearable in the cross direction. The invention further relates to sheets or tapes made from the adhesive articles and methods for making the adhesive article.

### BACKGROUND OF THE INVENTION

Pressure-sensitive adhesive materials are made up of an adhesive composition applied to a porous backing. The use of pressure-sensitive adhesive-coated sheet materials in the form of adhesive tapes, medical and surgical bandages, and surgical drapes for the management of skin wounds and to adhere or to secure medical devices such as intravenous needles is a widely used and well-accepted medical practice. Pressure-sensitive adhesive-coated tapes are also widely used in sports medicine for protection and safety of athletes, for example, for the wrapping of joints subject to stress during performance, as well as for treating injuries.

Pressure-sensitive adhesive-coated tapes generally are designed to adhere to a surface that is a source of moisture such as skin. The adhesive tape is desirably porous and breathable so that the moisture of the skin can be vented from the skin surface. When adequate moisture venting is not available, the accumulated water overhydrates and softens the outer layers of the skin (stratum corneum), thereby causing skin maceration. Further, the stratum corneum of the macerated skin is further damaged when the pressure-sensitive adhesive-coated sheet material is removed. Therefore, in order to prevent moisture-caused maceration of skin, the pressure-sensitive adhesive-coated sheet materials should preferably be composed of water vapor permeable substrate backings and non-irritating pressure-sensitive adhesives.

An additional desirable feature of pressure-sensitive adhesive tapes is uniform tear characteristics. The tape should tear easily and evenly in the cross direction when pressure is applied at a specific point along the edge. The adhesive tape also should have adequate strength so that the tape does not tear or break during application or normal use.

Pressure-sensitive adhesive compositions are commonly applied to breathable backings or tapes by coating the backings or tapes with an adhesive solution or dispersion in a suitable vehicle such as an organic solvent or water and evaporating the vehicle, or by coating the backings or tapes with an adhesive in the form of a hot melt. When the adhesive coating is applied as a continuous layer, however, the breathability of the porous backing diminishes significantly or is eliminated entirely.

A discontinuous adhesive coating on a breathable backing allows the skin to breathe, at least in the areas of the backing not coated with the adhesive. Thus, prior art processes have attempted to disrupt the continuity of the adhesive film coating to deposit a discontinuous film. Adhesive-backed tapes have been perforated using needle-like points to mechanically pierce the adhesive-backed tape after the application of the adhesive coating. Gas streams directed onto regions of the adhesive-coated porous web have also been used to form perforations in the adhesive-coated web at predetermined positions. Other techniques use intermittent coating of adhesives onto the backing. For example, adhesive is applied using patterned rolls, screen printing and release coated calendar roll processing similar to Gravure printing.

U.S. Pat. No. 2,740,403 describes a two-ply bandage having a closely woven outer fabric and an adhesive-coated open weave inner fabric. Although the open weave inner fabric retains its porosity upon being coated with adhesive, the open weave fabric is only marginally more porous than the outer backing fabric, and the breathability of the bandage is not improved significantly.

Pressure-sensitive adhesive tapes desirably maintain a minimum water vapor transmission (WVT) rate to allow for constant breathing of the skin when covered with the tape; however, the vapor permeability of prior art pressure-sensitive adhesive tapes is still unacceptably low for many applications.

### SUMMARY OF THE INVENTION

The present invention provides a water vapor permeable, pressure-sensitive adhesive article that is at once both convenient to use and economical to manufacture.

In one aspect of the invention, a pressure-sensitive article includes a porous backing substrate and an adhesive-carrying fabric applied to a surface of the backing substrate. The fabric has a porosity greater than that of the backing substrate and a tensile strength in the cross direction that is greater than the tensile strength in the machine direction. The adhesive of the adhesive-carrying fabric is located on the fabric in such a manner that the fabric remains porous.

In another aspect of the invention, a pressure-sensitive article includes a porous backing substrate and an adhesive-carrying fabric applied to a surface of the backing substrate. The fabric has a porosity greater than that of the backing substrate, and the adhesive of the adhesive-carrying fabric is located on the fabric in such a manner that the adhesive-carrying fabric remains porous and the adhesive penetrates into a portion of a thickness of the porous backing.

In another aspect of the invention, a pressure-sensitive article includes a porous backing substrate and an adhesive-carrying porous fabric having first and second surfaces. The adhesive is located on the porous fabric in such a manner that the adhesive-carrying fabric remains porous. The first surface of the open fabric is applied to a surface of the backing substrate, and the second surface is substantially coated with adhesive, wherein the second surface covers no more than 50% of the article surface area. The second surface can cover as little as about 5% of the article surface area. The article adheres securely to a substrate, e.g., skin surface, yet can be easily removed without damage to the underlying tissue.

In another aspect of the invention, a method of making a pressure-sensitive adhesive article includes applying an adhesive in a liquid carrier to a open fabric having an open structure in such a manner that the open structure of the open fabric remains open, contacting the adhesive-coated open fabric to a porous backing substrate in a manner such that the adhesive penetrates a distance into the backing substrate, and removing the liquid carrier. A breathable pressure-sensitive adhesive article is obtained.

The pressure-sensitive adhesive article is tack-free on one side to provide a soft, comfortable outer surface to the user. The open fabric is “anchored” to the other side of the backing by the adhesive so that the backing and open fabric remain intact during use. The adhesive does not block vapor and air flow through the backing because it is located on the open fabric and not between the weave of the open fabric. The pressure-sensitive adhesive tape of the present invention tears easily and evenly along the cross direction when pressure is applied at a specific point along the edge; however, the open fabric provides adequate strength in the machine direction so that it does not tear or break during normal application. Furthermore, the pressure-sensitive adhesive article provides good adhesive contact with tissue, for example, skin, yet can be easily removed without damage to the tissue.

The term “about” is used herein to mean approximately, in the region of, roughly or around. When the term “about” is used in conjunction with a numerical range, it modifies that range by extending the boundaries above and below the numerical values set forth. In general, the term “about” is used herein to modify a numerical value above and below the stated value with a variance of 10%.

### BRIEF DESCRIPTION OF THE DRAWING

The above mentioned and other features and advantages of the present invention will become more readily apparent from the following detailed description and the accompanying drawings, in which:

FIG. 1A is an enlarged plan view of a portion of a pressure-sensitive adhesive tape according to one or more embodiments of the invention;

FIG. 1B is a cross-sectional view of the pressure-sensitive adhesive tape of FIG. 1A shown at cross-section 1-1′;

FIG. 2 is an enlarged plan view of a portion of a pressure-sensitive adhesive tape according to one or more embodiments of the invention;

FIG. 3A is an enlarged plan view of a portion of a pressure-sensitive adhesive tape according to one or more embodiments of the invention;

FIG. 3B is a cross-sectional view of the pressure-sensitive adhesive tape of FIG. 3A shown at cross-section 3-3′; and

FIG. 4 shows diagrammatically an apparatus and process for producing one or more embodiments of the invention, in which the adhesive-carrying open fabric is adhered to the backing substrate.

### DETAILED DESCRIPTION OF THE INVENTION

A pressure-sensitive adhesive article includes a porous backing having an adhesive-carrying open fabric adhered thereto. The open fabric is of an open weave or knit and the adhesive is located only on the fabric yarns, threads or fibers without spanning or bridging of the adhesive between yarns, threads or fibers. In this way, the porosity of the backing is maintained so that a breathable article having high vapor permeability is obtained. In some embodiments, the adhesive penetrates a distance into the backing substrate to anchor the open fabric to the backing. In some other embodiments, the open layer is of unequal tensile strength in the cross and machine directions and thereby imparts different tear characteristics to the article in the machine direction (MD) and cross direction (CD). The open fabric provides sufficient strength to the article in the machine direction so that the tape does not fail during use; however, the strength of the tape in the cross direction permits an even and easy tear. In one or more embodiments, the tape is hand tearable. In still other embodiments, the pressure-sensitive adhesive article exhibits two or more of these features.

By “open structure” it is meant that the weave includes areas that are open or free of yarn or fibers (and adhesive). The open structure can include pores such as are typically found in non-woven fabrics, or it can be a much larger open structure such as a scrim or mesh. The openness of a structure is defined, for example, by pore size, thread count and/or % open area.

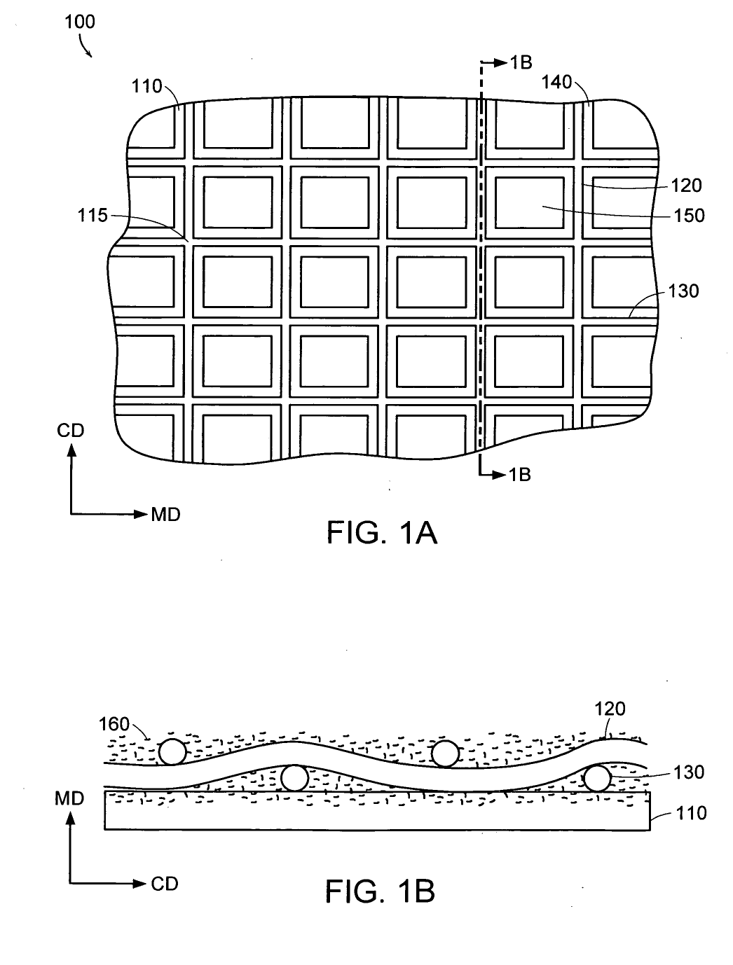

FIGS. 1A illustrates a pressure-sensitive adhesive article 100 according to some embodiments of the present invention. The article includes a porous backing 110 onto which an open fabric 115 is adhered. The open fabric 115 carries an adhesive 140 so that the open spaces 150 of the fabric are substantially free of adhesive and the porosity of the fabric is substantially unchanged. Adhesive 140 penetrates a distance into the porous backing 110 to secure the fabric 115 on one side of the porous backing. The open fabric 115 can be made up of CD yarns 120 and MD yarns 130 that reinforce and strengthen the pressure-sensitive adhesive article. FIG. 1B provides a cross-sectional view of the pressure-sensitive adhesive article across line 1-1′ of FIG. 1A. The adhesive 140 (shown as dotted matrix 160 in FIG. 1B) surrounds and permeates the CD yarns 120 and MD yarns 130 of open fabric 115. The adhesive matrix 160 also penetrates a distance into the backing 110. Note that the adhesive does not penetrate the full thickness of backing 110.

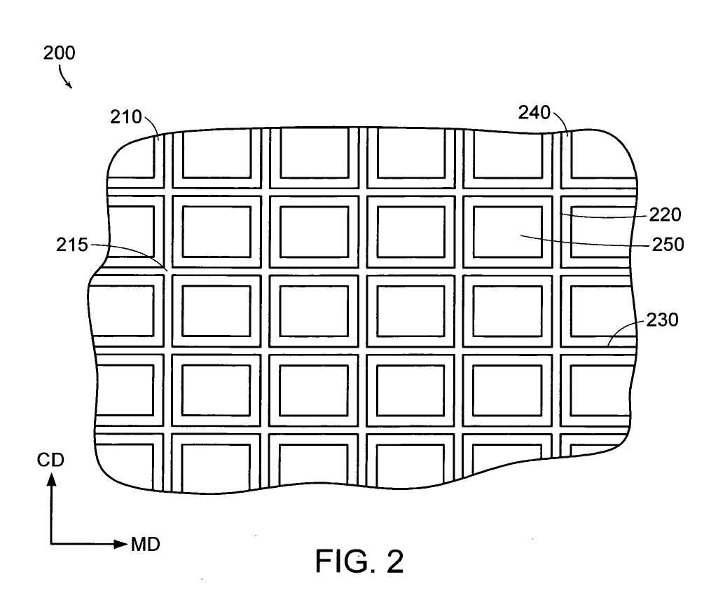

FIGS. 2 illustrates a pressure-sensitive adhesive article 200 according to one or more embodiments of the present invention in which the tensile strength of the CD and the MD yarns differs. The article includes a porous backing 210 onto which an open fabric 215 is adhered. As in the previous embodiment, the open fabric 215 carries an adhesive 240 so that the open spaces 250 of the fabric are substantially free of adhesive and the porosity of the fabric 215 is substantially unchanged. The open fabric 215 can be made up of CD yarns 220 and MD yarns 230 that reinforce and strengthen the pressure-sensitive adhesive article. CD yarns 220 can have a greater tensile strength than the MD yarns 230.

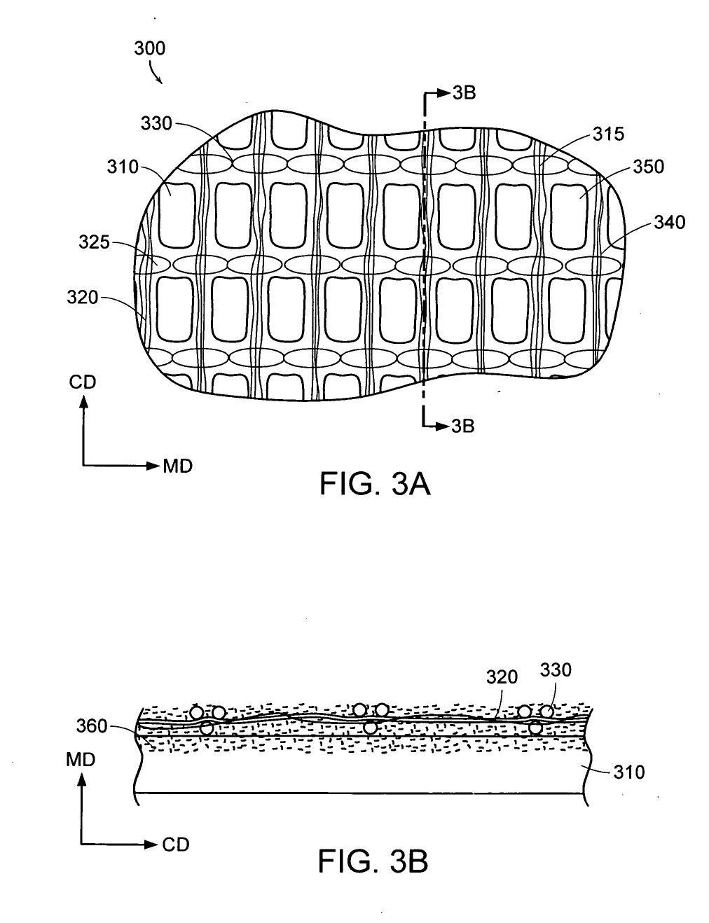

FIG. 3A illustrates yet another pressure-sensitive adhesive article 300 according to one or more embodiments of the invention in which an open knit fabric 315 is used. As in the article of FIG. 1A, the article includes a porous backing 310 onto which is adhered the open fabric 315. The open fabric 315 carries an adhesive 340 so that the open spaces 350 of the fabric are substantially free of adhesive and the porosity of the fabric is substantially unchanged. The open fabric 315 is made up of warp-knit (MD) yarns 330 having a weft (CD) yarn 320 inserted through a knit loop 325 of the warp knit yarn 330. The weft inserted yarns may include one or more filaments, the number and size of which are selected to have a desired tensile strength. By way of example only, the weft yarns are shown having three filaments; however, the weft yarns may be monofilament or multifilament. The weft yarns can have a number of filaments, for example, 3-15 filaments. FIG. 3B provides a cross-sectional view of the pressure-sensitive adhesive article across line 3-3′ of FIG. 3A. The adhesive 340 (shown as dotted matrix 360 in FIG. 3B) is shown surrounding and permeating the weft insert yarns 320 and warp knit yarns 330 of open fabric 315. The adhesive matrix 360 also penetrates a distance into the backing 310. Note that the adhesive does not penetrate the full thickness of backing 310.

The backing substrate is any conventional porous backing and can be a woven, knit or non-woven fabric. The backing fabric is not required to be of high tensile strength because the open fabric provides tensile strength in both the cross and machine directions. The porosity of the backing substrate is sufficient to provide a breathable, water vapor permeable membrane in the assembled pressure-sensitive tape. The backing substrate can be more than about 25% open area, and more than about 50% open area in some embodiments.

In a non-woven substrate backing, the fibers are intimately entangled with each other to form a coherent, breathable fibrous non-woven backing. The particular fiber composition used as a non-woven backing substrate is selected from those known in the prior art, according to the web property desired. For example, the non-woven substrate backing may be selected from the naturally occurring animal and vegetable fibers, including cotton and wool, or synthetic (chemical) fibers such as nylons, cellulosics, rayon, polyesters, polyamides, acrylics, polypropylene, polyethylene, and the like, including blends of such fibers. In one or more embodiments, the nonwoven fabric is lightweight and can typically be about 10-20 grams per square meter.

The non-woven substrate backing can further include a bonding agent or sizer to lock adjacent fibers of the non-woven fabric. The bonding agent promotes adhesion of the pressure-sensitive adhesive to individual yarns or fibers of the substrate backing when the pressure-sensitive adhesive and the backing are combined. Suitable bonding agents are selected from those known in the art, and can include, by way of example, homopolymers and copolymers of synthetic latexes such as butadiene, acrylics, vinyls and the like. The bonding agent is applied from a liquid carrier or solution at low solids levels so that the porosity of the non-woven is not impaired. The manner of applying the binding agent to the non-woven web is non-critical and any of the known methods of the coating art may be employed. Commercially available bonded non-woven fabrics can also be used in the articles of the present invention.

Woven or knit fabrics can also be used as a backing substrate and are selected from those known in the prior art. Exemplary fabrics include woven cotton fabrics, woven rayon, polyester or polypropylene fabrics and knit fabrics such as polyester, polypropylene and nylon knit fabrics.

The porous fabric having an open structure can be a woven or knit fabric. The openness of the fabric (which is a function of, for example, thread count and yarn denier) is selected so that the assembled structure, e.g., backing substrate, adhesive, and open fabric, is porous and vapor permeable. It is also selected to provide sufficient adhesive surface area to establish a strong adhesive contact with the backing substrate. The fabric can be up to about 95% open, i.e., 5% of surface area of the article is porous fabric, and is typically at least about 50% open. By way of example only, the open fabric can be an open weave fabric such as gauze, e.g., cotton or synthetic polymer gauze, or a warp-knit fabric.

In some embodiments, the open fabric exhibits a tensile strength differential in the machine and cross directions of the fabric. In order to provide warp and weft yarns of different tensile strength, yarns of different denier can be used. Denier is a unit of fineness for yarns, based upon 50 milligrams per 450 meters of yarn (1 denier). For fabrics using warp and weft yarns of the same or different material, differences in tensile strength can be achieved by using yarns of different denier, e.g., a “thin” yarn and a “thick” yarn. By way of example only, warp yarns of about 40-60 denier and weft yarns of about 70-150 denier have been used. In other embodiments, different warp and weft strengths are achieved by using yarns of different filament counts. By way of example only, a low denier monofilament is used as a warp yarn and a high denier multifilament yarn is used as the weft yarn.

In one or more embodiments, a knitted fabric can be used, in which the yarns are formed into stitches in a lengthwise (machine) direction and a weft (cross machine) insert yarn of same or different strength is inserted through the warp stitches to provide a fabric having the same or differing tensile strengths in the warp and weft directions. In some embodiments, the warp knit/weft insertion fabric has a weight of less than about 50 grams per square meter (about 1.5 oz. per square yard) or about 25-30 grams per square meter (about 0.7-0.9 oz. per square yard), and may be as low as 5 grams per square meter. An exemplary warp knit/weft insertion fabric has a weight ranging from about 25 to about 10 grams per square meter, and a warp/weft thread count ranging from about 18×12 to about 9×12. The knitted warp yarns are about 40 denier polyester, and the about 150 denier fill or weft yarns are loose, nontwisted, texturized polyester filaments. Similar warp knit/weft insertion fabrics are available commercially, e.g., warp knit/weft insertion greige fabric is available from Milliken & Company of Spartenburg, S.C. A warp knit/weft insertion construction provides a lightweight fabric having high tensile strength, e.g. about 12-13 lb/in², in the warp direction.

In one or more embodiments, the open fabric is characterized by a warp yarn(s) of lower tensile strength than the weft yarn(s). The difference in tensile strength gives rise to different tear characteristics in the cross or machine directions; and the arrangement of the weave provides a clean, even tear along the CD. The low stretch characteristics of the MD yarns tend to focus the load at the point of tear and cause the yarns to fail in a predictable manner. The stronger CD yarns tend to guide the tear and cause the tear to propagate between the CD yarns. The CD yarns also promote a straight tear across the structure and cause the fibers (of the nonwoven backing substrate) to break cleanly without a ragged, uneven edge.

In some embodiments, the pressure-sensitive adhesive tape can include elastic yarns, resulting in a self-wound pressure-sensitive tape having a degree of stretch (elongation) ranging from approximately 30% to 150%. The backing substrate and the open fabric can have substantially the same elasticity and extensibility.

A pressure-sensitive polymer is applied to the open fabric. Any pressure sensitive adhesive is useful for preparing the articles of the invention. Pressure-sensitive adhesives generally include elastomers that are inherently tacky or elastomers or thermoplastic elastomers that include tackifying resins and plasticizing additives. Fillers, antioxidants, stabilizers and crosslinking agents known in the art also may be used. A fluid, typically water, is added to reduce the viscosity to a level that is easily applied to the open fabric. The amounts and kinds of ingredients of the pressure-sensitive adhesive is selected to provide appropriate substrate adhesion and target peel strength. Strong substrate adhesion and a moderate peel strength are desired for use with living skin. Suitable pressure-sensitive adhesives include polyacrylate adhesives, polyalphaolefin adhesives, such as linear, radial, branched and tapered block copolymers including styrene-butadiene, styrene-ethylene/butylenes and styrene-isoprene block copolymers, polyvinyl acrylates, natural and synthetic rubber resin adhesives, silicones, polydiorganosiloxane polyurea copolymers, and mixture and blends thereof.

The adhesive is located at least on upper and lower surfaces of the open fabric. It covers the upper and lower surfaces without spanning adjacent yarns, so that porosity or openness is retained. In some embodiments, the adhesive is suffused or permeated throughout the entire thickness of the open fabric. The pressure-sensitive adhesive is selected to be removable from the skin without separation of the substrate backing from the open fabric.

The adhesive-coated open fabric adheres to the backing substrate by adhesive contact. Adhesion of the open fabric to the substrate is enhanced by partial penetration of the adhesive into a portion of the thickness of the backing substrate. Adhesive is absorbed by the backing only in those areas where the open fabric contacts the substrate. The open areas of the open fabric are substantially free of adhesive, so that no adhesive is transferred to the backing substrate in these areas. The adhesive does not saturate the full thickness of the backing, so that the side of the backing substrate opposite the open fabric is essentially free of adhesive. The two different tape surfaces make the pressure-sensitive tape self-winding and permit an even unwind of the tape from a roll. The adhesive can penetrate up to about 95% of the thickness of the backing substrate, and in some embodiments, the adhesive penetrates into about 25% to about 75% of the backing thickness. Typically, the adhesive penetrates about 50% of the backing thickness.

Because the adhesive-carrying open fabric retains its openness, the vapor permeability of the article remains high. Microporosity and water vapor permeability can be measured in a variety of ways, for example, by measuring the amount of air expressed in mL/min by a known surface at a certain pressure. Pressure-sensitive adhesive tapes desirably maintain a maximum water vapor transmission rate. An exemplary tape prepared according to one or more embodiments of the invention had a water vapor transmission (WVT) of 28 grains/ft²-h (water method) (ASTM: E96-00^{ε}^{₁}), which represents at least about a 25% improvement over current industry standards.

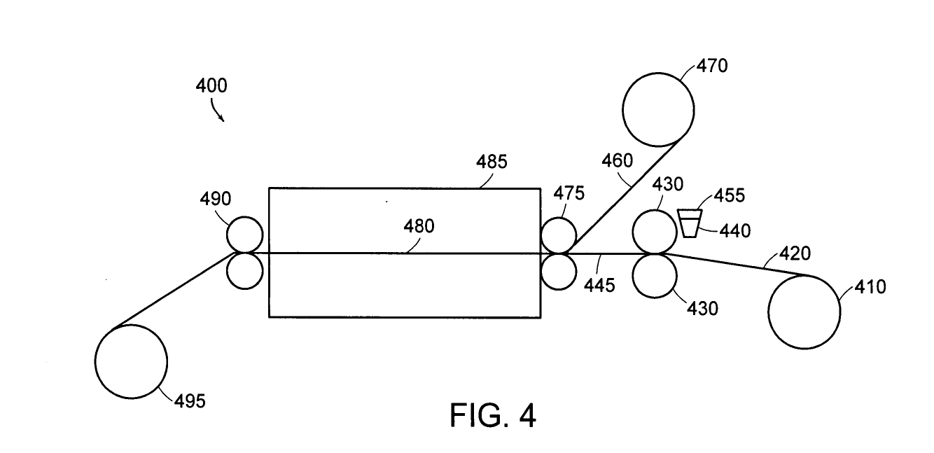

An apparatus 400 for preparing the pressure-sensitive adhesive coatings of the invention is shown schematically in FIG. 4. The apparatus 400 includes a feed roll 410 for supplying an open fabric 420.

The open fabric 420 is guided into nip rolls 430 that supply a metered amount of an adhesive 440 to the fabric from reservoir 455. The adhesive composition includes an adhesive and a carrier liquid, preferably water. The adhesive composition is of a solids content and viscosity that permits impregnation and coating of the yarns of the open fabric, yet avoids spanning of the adhesive across adjacent yarns. Although the actual composition may vary depending upon the particular adhesive and open fabric used, typical adhesive solutions contain about 20-50 wt % adhesive solids. Additives, e.g., antifoaming agent, can be added to improve the machinability of the adhesive. The coating process applies sufficient adhesive to saturate the fibers of the fabric but not to form a continuous adhesive coating. Thus, the porosity of the open fabric is substantially unaffected by adhesive application. The open area of the fabric is reduced by no more than about 20%, or even no more than about 10%. By way of example, an open fabric that initially contains about 90% open area is reduced to about 80% open area upon coating with adhesive.

The adhesive-coated fabric 445 next is transported to nip rolls 475. A backing substrate 460 is fed from feed roll 470 and is contacted to the surface of the adhesive-coated fabric 445 at nip 475 to form a laminate structure 480. The adhesive is sufficiently viscous such that the adhesive does not bleed through the entire thickness of the backing substrate 460; however, the adhesive is able nonetheless to penetrate the backing substrate 460 to anchor the open fabric 445. The laminate structure 480 then is passed through heater 485 and at least one roller 490 to dry the laminate structure 480 and to secure the open fabric to the backing. The heater can be heated air, heat lamps, or any other conventional source of heat. Essentially all of the carrier liquid is removed in the drying step. The finished product then is wound onto take-up roll 495.

The foregoing detailed description includes many specific details. The inclusion of such detail is for the purpose of illustration only and should be understood not to limit the invention. In addition, features in one embodiment may be combined with features in other embodiments of the invention. Various changes may be made without departing from the spirit and scope of the invention as defined in the following claims

1. An article comprising:
a porous backing substrate; and
an adhesive-carrying fabric applied to a surface of the backing substrate, the fabric having a porosity greater than that of the backing substrate and a tensile strength in the cross direction that is greater than the tensile strength in the machine direction, and the adhesive of the adhesive-carrying fabric located on the fabric in such a manner that the fabric remains porous.

2. An article comprising:
a porous backing substrate; and
an adhesive-carrying fabric applied to a surface of the backing substrate, the fabric having a porosity greater than that of the backing substrate, and the adhesive of the adhesive-carrying fabric located on the fabric in such a manner that the adhesive-carrying fabric remains porous and the adhesive penetrates into a portion of a thickness of the porous backing.

3. An article comprising:
a porous backing substrate; and
an adhesive-carrying porous fabric having first and second surfaces, the adhesive located on the porous fabric in such a manner that the adhesive-carrying fabric remains porous, said first surface of the open fabric applied to a surface of the backing substrate, and said second surface substantially coated with adhesive, wherein said second surface covers no more than 50% of the article surface area.

4. The article of claim 1, 2, or 3, wherein the porous backing substrate is selected from the group consisting of woven, knit and non-woven fabrics.

5. The article of claim 1, 2, or 3, wherein the adhesive-carrying fabric is selected from the group consisting of woven, non-woven and knit fabrics.

6. The article of claim 1, 2, or 3, wherein the adhesive-carrying fabric comprises a warp knit fabric.

7. The article of claim 6, wherein the warp knit fabric comprises a weft insert yarn.

8. The article of claim 1, 2, or 3, wherein the backing substrate and the adhesive-carrying fabric are of substantially the same elasticity and extensibility.

9. The article of claim 1, 2, or 3, wherein the adhesive-carrying fabric comprises more than 80% open area prior to application of the adhesive.

10. The article of claim 9, wherein the % open area of the adhesive-carrying fabric is reduced by no more than about 10% upon application of the adhesive.

11. The article of claim 1, 2 or 3, wherein the porous backing substrate comprises greater than about 25% open area.

12. The article of claim 1, 2 or 3, wherein the porous backing substrate comprises greater than about 50% open area.

13. The article of claim 1 or 3, wherein the adhesive penetrates into the one surface of the backing substrate.

14. The article of claim 2, wherein the adhesive penetrates into about 25% to 75% of the thickness of the backing substrate.

15. The article of claim 1, 2 or 3, wherein the adhesive has sufficient internal cohesive strength that the article is removable from a substrate without separation of the backing substrate and the adhesive-carrying fabric.

16. The article of claim 1, wherein the article tears uniformly in the cross machine direction.

17. The article of claim 1, 2 or 3, further comprising elastic yarns, said yarns extensible in the machine direction.

18. A method of making a pressure-sensitive adhesive article, comprising:
applying an adhesive in a liquid carrier to an open fabric having an open structure in such a manner that the open structure of the open fabric remains open;
contacting the adhesive-coated open fabric to a porous backing substrate in a manner such that the adhesive penetrates a distance into the backing substrate;
and removing the liquid carrier to obtain a breathable pressure-sensitive adhesive article.

19. The method of claim 18, wherein the open fabric has a tensile strength in the cross direction that is greater than the tensile strength in the machine direction.

20. The method of claim 18, wherein the step of applying the adhesive comprises passing the adhesive-coated open fabric through a roller to remove excess adhesive.

21. The method of claim 18, wherein the step of removing the liquid carrier of the adhesive comprises heating the article.

22. The method of claim 21, wherein essentially all of the liquid carrier of the adhesive is removed.

23. The method of claim 18, wherein the adhesive penetrates through up to about 95% of the backing thickness.

24. The method of claim 18, wherein the adhesive penetrates through about 25% to about 75% of the backing thickness.

25. The method of claim 18, wherein the porous backing is selected from the group consisting of woven, knit and non-woven fabrics.

26. The method of claim 18, wherein the open fabric is selected from the group consisting of woven, non-woven and knit fabrics.

27. The method of claim 18, wherein the open area of the open fabric is reduced by no more than about 10% upon coating with adhesive.
